(19) United States
(12) Patent Application Publication
(10) Pub. No.: US 2024/0234734 A1
(43) Pub. Date: Jul. 11, 2024

(54) USING FUNCTIONAL GROUPS IN CONDUCTING AGENTS FOR MN-BASED CATHODE MATERIALS

(71) Applicant: Rivian IP Holdings, LLC, Plymouth, MI (US)

(72) Inventors: Soo KIM, Fremont, CA (US); Yumi KIM, San Jose, CA (US); Sookyung JEONG, San Jose, CA (US); Tae Kyoung KIM, Albany, CA (US); Ki Tae PARK, Santa Clara, CA (US)

(21) Appl. No.: 18/090,071

(22) Filed: Dec. 28, 2022

(51) Int. Cl. H01M 4/62; H01M 10/0525

(52) U.S. Cl. CPC H01M 4/625; H01M 4/621; H01M 10/0525; H01M 2004/028

(57) ABSTRACT

Provided are lithium-ion batteries comprising a positive electrode comprising a first conducting agent comprising one or more oxide-containing functional groups.

### INTRODUCTION

The present disclosure generally relates to positive electrodes, and more particularly, to the use of carbon oxygen functional groups to minimize manganese dissolution in Mn-based positive electrode materials.

### SUMMARY

Provided herein are positive electrodes comprising a functionalized conducting agent, lithium-ion batteries comprising said positive electrodes, and electric vehicle systems comprising said lithium-ion batteries. The positive electrodes having functionalized conducting agent described herein can minimize the amount of manganese dissolution in Mn-based positive electrodes. Manganese dissolution in Mn-based cathode materials can cause capacity loss and an increase in the overpotential on the negative electrode side of the battery, particularly if the free manganese ion (e.g., Mn²⁺_{(aq.)}, Mn³⁺_{(aq.)}, etc.) is reduced to metallic manganese (Mn⁰). Thus, positive electrodes comprising functional groups as described herein can help minimize manganese dissolution in Mn-based cathode materials.

The positive electrodes described herein can include both modified conducting agent (i.e., a first conducting agent) and unmodified conducting agent (i.e., a second conducting agent). Both the first and the second conducting agents can include amorphous carbon, graphite, graphene, carbon nanotubes (e.g., single-walled carbon nanotubes, multi-walled carbon nanotubes) and/or combination thereof. In some embodiments, the first conducting agent is modified to include one or more oxide-containing functional groups. For example, the one or more oxide-containing functional groups can include a carbonyl functional group, a carboxylic functional group, an epoxy functional group, a hydroxyl functional group, or a combination thereof.

In some embodiments, provided is a lithium-ion battery comprising: a positive electrode comprising a first conducting agent comprising one or more oxide containing functional groups.

In some embodiments of the lithium-ion battery, the first conducting agent comprises: graphene, graphite, graphene oxide, graphite oxide, reduced graphene oxide, single-walled nanotubes, multiwalled-nanotubes, or a combination thereof.

In some embodiments of the lithium-ion battery, the positive electrode comprises a second conducting agent.

In some embodiments of the lithium-ion battery, a weight ratio of the second conducting agent to the first conducting agent is 2:1 to 9:1.

In some embodiments of the lithium-ion battery, the first conducting agent comprises multiwalled carbon nanotubes, the second conducting agent comprises multiwalled carbon nanotubes, or a combination thereof.

In some embodiments of the lithium-ion battery, the first conducting agent comprises single walled carbon nanotubes, the second conducting agent comprises single walled carbon nanotubes, or a combination thereof.

In some embodiments of the lithium-ion battery, the first conducting agent comprises functionalized carbon nanotubes.

In some embodiments of the lithium-ion battery, a flake size of graphene oxide used to form the functionalized carbon nanotubes of the first conducting agent is from 0.1 to 25 μm.

In some embodiments of the lithium-ion battery, a flake size of graphene oxide used to form the functionalized carbon nanotubes of the first conducting agent is from 0.1-2 μm.

In some embodiments of the lithium-ion battery, a ratio of flake size of graphene oxide used to form the functionalized carbon nanotubes of the first conducting agent to a particle size of an active material is 2:1-40:1.

In some embodiments of the lithium-ion battery, the one or more oxide-containing functional groups is configured to react with manganese ions.

In some embodiments of the lithium-ion battery, the one or more oxide-containing functional groups is configured to react with residual water.

In some embodiments of the lithium-ion battery, the one or more oxide-containing functional groups is configured to react with hydrogen fluoride.

In some embodiments of the lithium-ion battery, the one or more oxide-containing functional groups is configured to react with nitrogen ions, phosphorus ions, sulfur ions, or a combination thereof.

In some embodiments of the lithium-ion battery, the positive electrode comprises LMFP, LMO, LiMO₂, Li₁₊ₓM₁₋ₓO₂, or Li₂MnO₃.

In some embodiments of the lithium-ion battery, the one or more oxide-containing functional groups comprise a carbonyl functional group, a carboxylic functional group, an epoxy functional group, a hydroxyl functional group, or a combination thereof.

In some embodiments of the lithium-ion battery, the positive electrode comprises 90-99 wt. % active material, 0.5-5 wt. % conducting agent, and 0.5-5 wt. % binder.

In some embodiments, provided is an electric vehicle system comprising a lithium-ion battery comprising a positive electrode comprising a first conducting agent comprising one or more oxide containing functional groups.

In some embodiments, provided is a method of preparing a cathode, the method comprising: mixing a first conducting agent, a binder solution, a solvent, an active material, and a second conducting agent to form an electrode slurry, wherein the first conducting agent comprises one or more oxide-containing functional groups.

In some embodiments of the method, the first conducting agent is added to the mixture after the mixing the second conducting agent, the binder solution, then solvent, and the active material.

The embodiments disclosed above are only examples, and the scope of this disclosure is not limited to them. Particular embodiments may include all, some, or none of the components, elements, features, functions, operations, or steps of the embodiments disclosed above. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE FIGURES

FIG. 1 shows a process for forming reduced graphene oxide, according to some embodiments:

FIG. 2 provides a depiction of different oxide-containing functional groups on graphene oxide, according to some embodiments:

FIG. 3 shows the X-ray photoelectron spectroscopy (XPS) binding energy of various oxide-containing functional groups in the Cls spectrum, according to some embodiments:

FIG. 4 shows the relative reactivity of various oxide-containing functional groups with water and hydrogen fluoride, according to some embodiments:

FIG. 5 shows the relative manganese ion binding energy of various oxide-containing functional groups, according to some embodiments:

FIG. 6 shows a method of preparing an electrode slurry comprising a functionalized conducting agent, according to some embodiments:

FIG. 7 shows the electrode resistivity of a control electrode and an electrode comprising modified/functionalized conducting agent, according to some embodiments:

FIG. 8 illustrates a flow chart for a typical battery cell manufacturing process, according to some embodiments:

FIG. 9 depicts an illustrative example of a cross sectional view of a cylindrical battery cell, according to some embodiments;

FIG. 10 depicts an illustrative example of a cross sectional view of a prismatic battery cell, according to some embodiments;

FIG. 11 depicts an illustrative example of a cross section view of a pouch battery cell, according to some embodiments:

FIG. 12 illustrates cylindrical battery cells being inserted into a frame to form a battery module and pack, according to some embodiments;

FIG. 13 illustrates prismatic battery cells being inserted into a frame to form a battery module and pack, according to some embodiments:

FIG. 14 illustrates pouch battery cells being inserted into a frame to form a battery module and pack, according to some embodiments; and

FIG. 15 illustrates an example of a cross sectional view of an electric vehicle that includes at least one battery pack, according to some embodiments.

In the Figures, like reference numerals refer to like components unless otherwise stated herein.

### DETAILED DESCRIPTION

Provided herein are positive electrodes comprising a modified conducting agent. The modified conducting agent may include amorphous carbon, graphite, graphene, and/or carbon nanotubes (e.g., single-walled carbon nanotubes, multi-walled carbon nanotubes) modified with oxide-containing functional groups. Also provided are lithium-ion batteries comprising said positive electrodes, and electrode vehicle systems comprising said lithium-ion batteries.

In manganese-based positive electrodes, manganese dissolution can cause capacity loss and an increase in the overpotential on the negative electrode side of the battery, particularly if the free manganese ion (e.g., Mn²⁺_{(aq.)}, Mn³⁺_{(aq.)}, etc.) is reduced to metallic manganese (Mn⁰).

Thus, there is a need to minimize or eliminate manganese dissolution in Mn-based positive electrode materials, to improve the energy density and longevity of the cell.

Accordingly, provided herein are conducting agents used in Mn-based positive electrodes that have been modified or functionalized with oxide-containing functional groups. The oxide-containing functional groups can participate in various chemical reactions occurring within the electrode/battery to minimize the amount of manganese dissolution.

Below, Equation 1 shows hydrolysis of lithium hexafluorophosphate (LiPF₆), a common electrolyte material in lithium-ion batteries. The LiPF₆ reacts with water contamination in the electrolyte of the battery, releasing hydrogen fluoride (HF) acid. HF acid decreases battery performance when reacting with battery subcomponents and can be a health hazard in the event of a leakage.

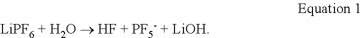

Reaction 2, below, shows LiPF₆ breaking down into lithium fluoride (LiF) and phosphorus pentafluoride (PF₅). As shown in Equation 3, the PFs can then react with residual water, forming more HF as well as phosphoryl fluoride (POF₃).

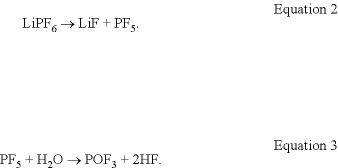

The HF from Equations 1 and 3 can then attack the positive electrode materials, accelerating manganese dissolution. As shown in Equation 4, HF reacts with the manganese, forming manganese fluoride and hydrogen gas.

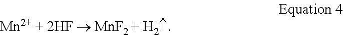

The modified conducting agents used herein to prepare the Mn-based cathode materials comprise one or more oxide-containing functional groups that can react with one or more chemical components of the above equations 1-3, preventing HF from attacking the cathode materials and thereby causing manganese dissolution. This is described in more detail below.

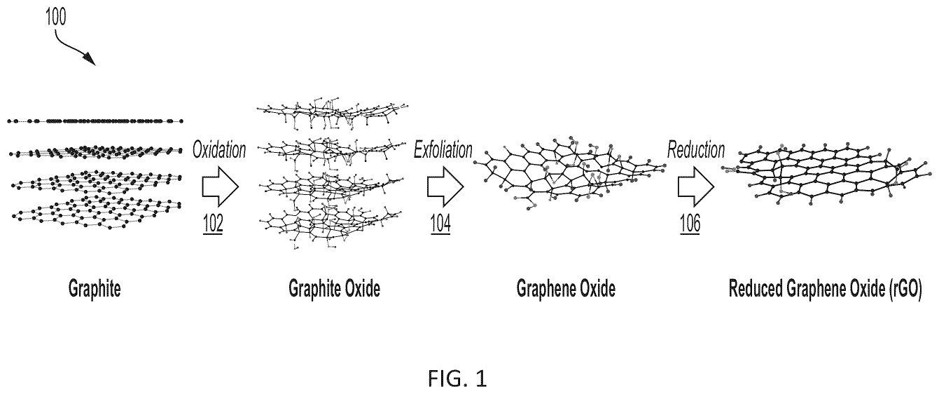

FIG. 1 shows a process 100 for forming reduced graphene oxide, according to some embodiments. At step 102, graphite is oxidized to form graphite oxide using a Hummers' method. A Hummers' method is a chemical process that generate graphite oxide with potassium permanganate to a solution including graphite, sodium nitrate, and sulfuric acid. This process increases the interlayer spacing and functionalization of the basal planes of graphite. The graphite oxide comprises a plurality of oxide-containing functional groups such as, but not limited to, a carbonyl functional group, a carboxylic functional group, an epoxy functional group, a hydroxyl functional group, or a combination thereof. At step 104, the graphite oxide is exfoliated to form graphene oxide. The addition of persulfate (S₂O₈²⁻) ensures the oxidation and ease to exfoliate graphite that can yield suspended individual graphite oxide sheet. At step 106, the graphene oxide may be reduced to form reduced graphene oxide (rGO). Reduction of the graphene oxide removes some of the abundant oxygen functional groups to restore the electronic conductivity.

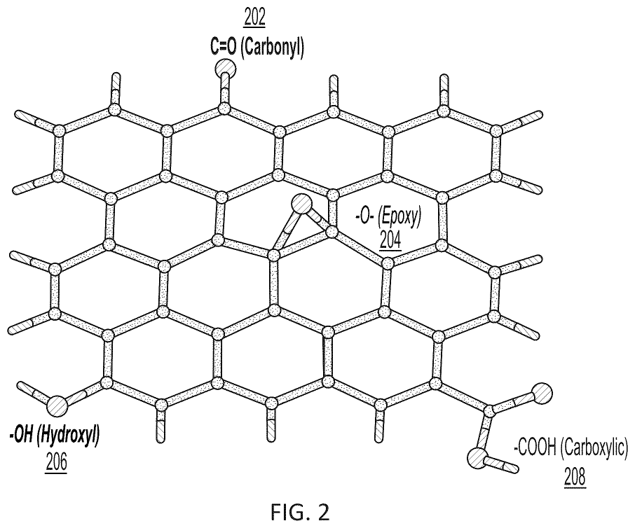

FIG. 2 provides a depiction of different oxide-containing functional groups on graphene oxide, according to some embodiments. Functional group 202 is a carbonyl functional group (═O). Functional group 204 is an epoxy functional group (—O—). Functional group 206 is a hydroxyl functional group (—OH). Functional group 208 is a carboxylic functional group (—COOH). In some embodiments, the carboxy lic function group and/or the hydroxyl functional group can exist in their corresponding anionic or salt forms with the hydrogen removed. The modified conducting agent may comprise any one of these oxide-containing functional groups, or a combination of any two or more of the oxide-containing functional groups.

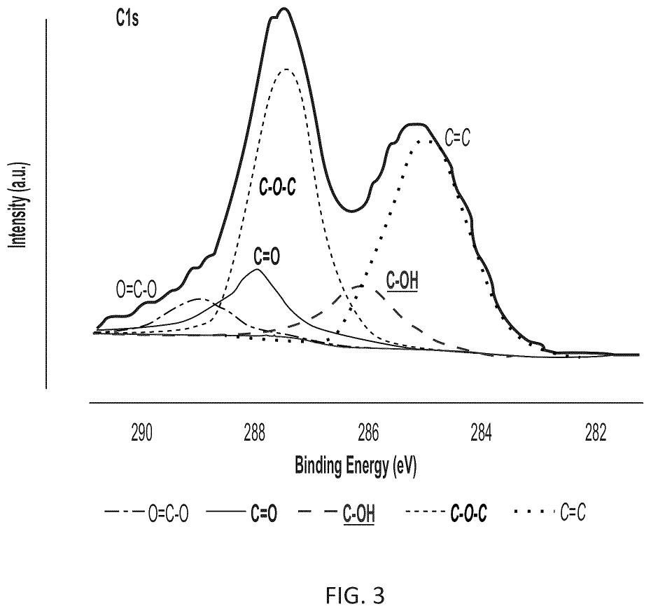

FIG. 3 shows the X-ray photoelectron spectroscopy (XPS) Cls binding energy of various oxide-containing functional groups, according to some embodiments. The C═C bond at ˜284 eV displays the surface bonding nature from the C═C double bond from the carbon ring. The C—OH at ˜286 eV exhibits the presence of hydroxyl group. The C—O (carbonyl), —O— (epoxy), and —COOH are also displayed peak signals at ˜287, ˜289 and ˜289 eV. Both peak height and area may be used to qualitatively compare the signals of bonding nature at the surface of the materials in FIG. 3.

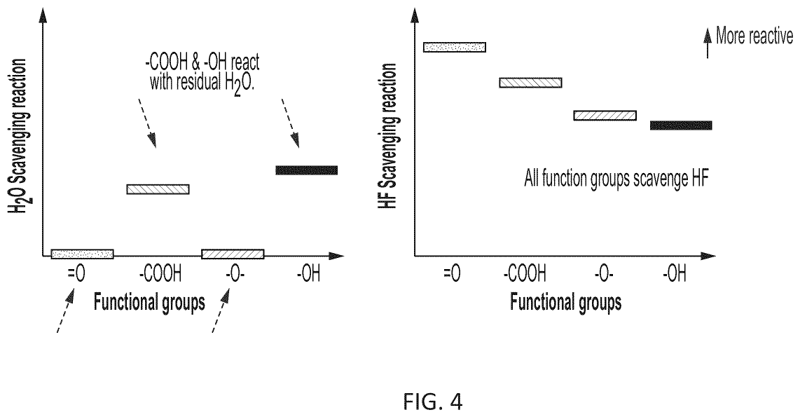

FIG. 4 shows the relative reactivity of various oxide-containing functional groups with water and hydrogen fluoride, according to some embodiments. As described above, there are various chemical equations occurring within a lithium-ion battery that can lead to manganese dissolution. The first (left) graph of FIG. 4 shows the relative affinity of each of four different oxide-containing functional groups for reacting with a water molecule. As shown, carboxylic functional groups and hydroxyl functional groups react more readily react with water than epoxy or carbonyl functional groups. The carboxylic and hydroxyl functional groups may react with the residual water of Equation 1 or 3. If one of these oxide-containing functional groups reacts with the residual water of Equation 1 or 3, this can prevent or minimize the formation of HF. Preventing or minimizing the formation of HF can in turn minimize the dissolution of manganese from the host cathode material at the surface.

The second (right) graph of FIG. 4 shows the relative affinity of each of four different oxide-containing functional groups for reacting with HF. As shown, carbonyl functional groups are the most reactive with HF, and hydroxyl functional groups are the least reactive with HF. Carboxylic functional groups are slightly less reactive to HF than carbonyl, and epoxy functional groups are slightly less reactive than carboxylic functional groups. All of these four oxide-containing functional groups may react with the HF of Equation 1, 3, or 4. When these oxide-containing functional groups react with the HF of Equations 1, 3, or 4, it can minimize or prevent the HF from attacking the Mn-based positive electrode material. Preventing or minimizing the HF from attacking the Mn-based positive electrode material can in turn minimize the dissolution of manganese.

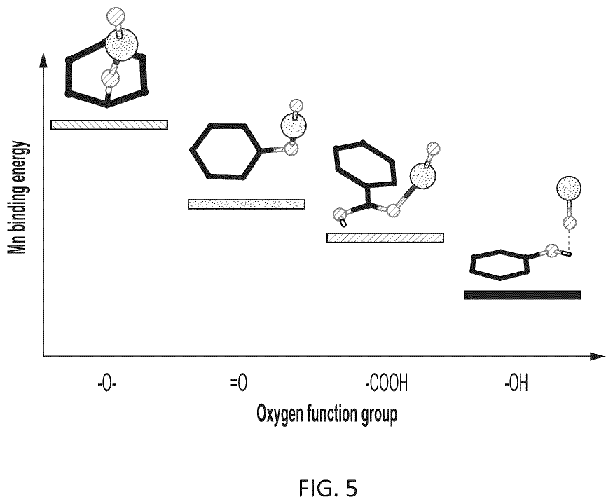

FIG. 5 shows the manganese ion binding energy of various oxide-containing functional groups, according to some embodiments. As shown, each of the four oxide-containing functional groups (carbonyl functional groups, epoxy functional groups, hydroxyl functional groups, and carboxylic functional groups) have an affinity for manganese ions. Thus, if some manganese ions dissolve from the cathode materials, these manganese ions can favorably bind to any one of these oxide-containing functional groups, preventing the ions from forming manganese metal (i.e., reduced oxidation state). Preventing or minimizing the amount of manganese ions that form manganese metal can reduce any capacity loss and any increase the overpotential on the negative electrode side of the battery otherwise caused by this process.

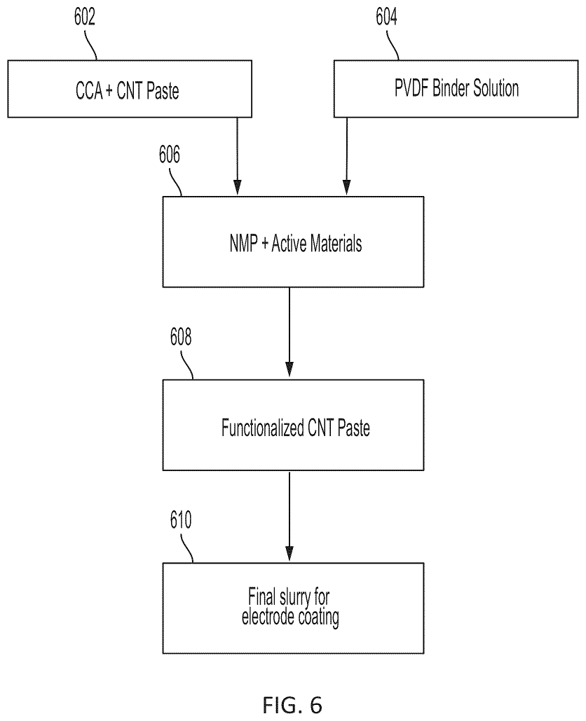

FIG. 6 shows a method of preparing an electrode slurry comprising a functionalized conducting agent, according to some embodiments. At step 602, a conductive carbon agent and carbon nanotube (CNT) (or, other functionalized/specialized CNT, graphene, etc.) mixture is formed. In some embodiments, this mixture may comprise 0.5-5 wt. % of the total amount of solids. In some embodiments, this mixture may comprise less than or equal to 5, 4.9, 4.8, 4.7, 4.6, 4.5, 4.4, 4.3, 4.2, 4.1, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, or 0.6 wt. % of the total amount of solids. In some embodiments, this mixture may comprise greater than or equal to 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, or 4.9 wt. % of the total amount of solids. In some embodiments, there may be no mixture, but instead comprise 100% carbon conducting agent or 100% carbon nanotubes. In some embodiments, this component may comprise 100% carbon nanotubes and comprise less than or equal to 2 wt. % of the total amount of solid contents of electrode (excluding the solvent such as n-methyl-pyrrolidone, NMP).

At step 606, the mixture of 602 including carbon conducting agent (CCA) and/or carbon nanotube (CNT) and the binder 604 are combined with the active materials of the positive electrode (e.g., n-methyl-pyrrolidone). In some embodiments, binder 604 may comprise polyvinylidene fluoride (PVDF). At step 608, functionalized carbon nanotube paste is added to form the final electrode slurry of step 610.

Although FIG. 6 shows the functionalized conducting agent added to the mixture after the non-functionalized or unmodified conducting agent, this is only one example. In some embodiments, the functionalized conducting agent may be added at the same time as the non-functionalized conducting agent, or before the non-functionalized conducting agent. By utilizing a step-wise mixing process as depicted in FIG. 6, an electrode may be formed with a functionalized surface or coating.

In some embodiments, a manganese-based positive electrode can comprise 90-99 wt. % active material. In some embodiments, the electrode can comprise less than or equal to 99, 98.9, 98.8, 98.7, 98.6, 98.5, 98.4, 98.3, 98.2, 98.1, 98, 97.9, 97.8, 97.7, 97.6, 97.5, 97.4, 97.3, 97.2, 97.1, 97, 96.9, 96.8, 96.7, 96.6, 96.5, 96.4, 96.3, 96.2, 96.1, 96, 95.9, 95.8, 95.7, 95.6, 95.5, 95.4, 95.3, 95.2, 95.1, 95, 94.9, 94.8, 94.7, 94.6, 94.5, 94.4, 94.3, 94.2, 94.1, 94, 93.9, 93.8, 93.7, 93.6, 93.5, 93.4, 93.3, 93.2, 93.1, 93, 92.9, 92.8, 92.7, 92.6, 92.5, 92.4, 92.3, 92.2, 92.1, 92, 91.9, 91.8, 91.7, 91.6, 91.5, 91.4, 91.3, 91.2, 91.1, 91, 90.9, 90.8, 90.7, 90.6, 90.5, 90.4, 90.3, 90.2, or 90.1 wt. % active material. In some embodiments, the electrode can comprise greater than or equal to 90, 90.1, 90.2, 90.3, 90.4, 90.5, 90.6, 90.7, 90.8, 90.9, 91, 91.1, 91.2, 91.3, 91.4, 91.5, 91.6, 91.7, 91.8, 91.9, 92, 92.1, 92.2, 92.3, 92.4, 92.5, 92.6, 92.7, 92.8, 92.9, 93, 93.1, 93.2, 93.3, 93.4, 93.5, 93.6, 93.7, 93.8, 93.9, 94, 94.1, 94.2, 94.3, 94.4, 94.5, 94.6, 94.7, 94.8, 94.9, 95, 95.1, 95.2, 95.3, 95.4, 95.5, 95.6, 95.7, 95.8, 95.9, 96, 96.1, 96.2, 96.3, 96.4, 96.5, 96.6, 96.7, 96.8, 96.9, 97, 97.1, 97.2, 97.3, 97.4, 97.5, 97.6, 97.7, 97.8, 97.9, 98, 98.1, 98.2, 98.3, 98.4, 98.5, 98.6, 98.7, 98.8, or 98.9 wt. % active material.

In some embodiments, a manganese-based positive electrode can comprise 0.5-5 wt. % conducting agent (including any carbon nanotubes). In some embodiments, the electrode can comprise less than or equal to 5, 4.9, 4.8, 4.7, 4.6, 4.5, 4.4, 4.3, 4.2, 4.1, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, or 0.6 wt. % conducting agent. In some embodiments, the electrode can comprise greater than or equal to 0.5, 0.6, 0.7, 0.8, 0.9, 1, 1.1, 1.2, 1.3, 1.4, 1.5, 1.6, 1.7, 1.8, 1.9, 2, 2. 1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, or 4.9 wt. % conducting agent.

In some embodiments, a manganese-based positive electrode can comprise 0.5-5 wt. % binder. In some embodiments, the electrode can comprise less than or equal to 5, 4.9, 4.8, 4.7, 4.6, 4.5, 4.4, 4.3, 4.2, 4.1, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, or 0.6 wt. % binder. In some embodiments, the electrode can comprise greater than or equal to 0.5, 0.6, 0.7, 0.8, 0.9, 1, 1.1, 1.2, 1.3, 1.4, 1.5, 1.6, 1.7, 1.8, 1.9, 2, 2. 1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, or 4.9 wt. % binder.

In some embodiments, the total amount of active material, conducting agent, and binder is 100 wt. %.

In some embodiments, the electrode can include a first conducting agent and a second conducting agent. The first conducting agent may be modified or functionalized with oxide-containing functional groups. The second conducting agent may be unmodified. In some embodiments, the first conducting agent and the second conducting agent comprise graphene, graphite, graphene oxide, graphite oxide, reduced graphene oxide, single-walled nanotubes, multiwalled-nanotubes, or a combination thereof. In some embodiments, the first conducting agent comprises functionalized carbon nanotubes. The flake size of graphene oxide used to form the functionalized carbon nanotubes may be from 0.1 to 25 μm or from 0.1 to 2 μm. In some embodiments, the flake size may be less than or equal to 25, 20, 15, 10, 5, 1, or 0.5 μm. In some embodiments, the flake size may be greater than or equal to 0.1, 0.5, 1, 5, 10, 15, or 20 μm.

In some embodiments, a ratio of flake size of graphene oxide used to form the functionalized carbon nanotubes of the first conducting agent to a particle size of an active material particle (e.g., LMFP particle) is 2:1 to 500:1 or 2:1 to 40:1. In some embodiments, the ratio may be less than or equal to 500:1, 400:1, 300:1, 200:1, 100: 1, 75:1, 50:1, 25:1, 10:1, or 5:1. In some embodiments, the ratio may be greater than or equal to 2:1, 5:1, 10:1, 25:1, 50:1, 75:1, 100:1, 200:1, 300:1, or 400:1.

In some embodiments, a carbonyl functional group, a carboxy lic functional group, an epoxy functional group, a hydroxyl functional group, or a combination thereof of the first conducting agent is configured to react with manganese ions. In some embodiments, the first conducting agent comprises a carboxylic functional group, a hydroxyl functional group, or a combination thereof configured to react with residual water. In some embodiments, the first conducting agent comprises a carbonyl functional group, a carboxylic functional group, an epoxy functional group, a hydroxyl functional group, or a combination thereof configured to react with hydrogen fluoride. In some embodiments, the first conducting agent comprises a carboxylic functional group, an epoxy functional group, a hydroxyl functional group, or a combination thereof configured to react with one or more of nitrogen ions, phosphorus ions, or sulfur ions.

In some embodiments, a weight ratio of the non-functionalized conducting agent to the functionalized conducting agent is 2:1 to 9:1. In some embodiments, the weight ratio of the non-functionalized conducting agent to the functionalized conducting agent is less than or equal to 9:1, 4:1, or 7:3. In some embodiments, the weight ratio of the non-functionalized conducting agent to the functionalized conducting agent is greater than or equal to 2:1, 7:3, or 4:1.

In some embodiments, the positive electrode comprises a LMFP, LMO, LiMO₂, Li₁₊ₓM₁₋ₓ O₂, or Li₂MnO₃, or a combination thereof.

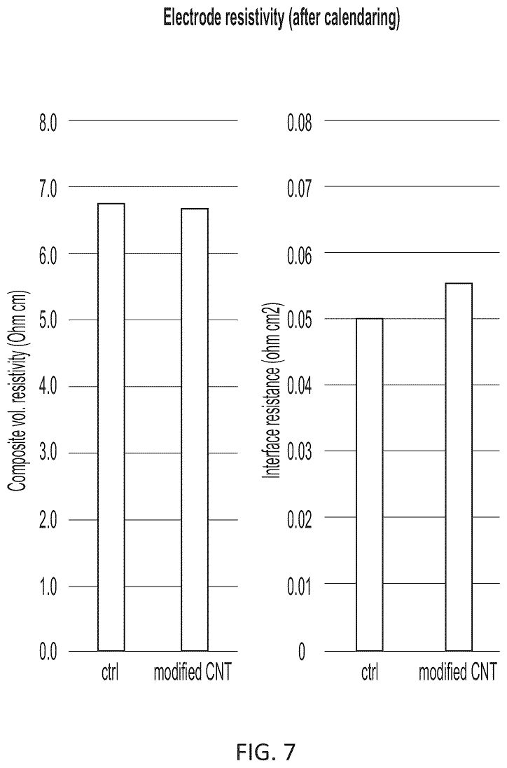

FIG. 7 shows the electrode resistivity of a control electrode and an electrode comprising modified/functionalized conducting agent, according to some embodiments. Lower resistivity is better to reduce cell resistance. However, the modified functional group reduces the conductivity, which increases the resistance. Therefore, it is essential to populate enough functional groups that can capture the Mn ions but to maintain similar resistivity. Electrode calendaring (i.e., pressing) help reducing the electrode thickness. Lit ions and electrons, therefore, can reduce the total distance to be travelled. The total composite volume resistivity (left panel) can represent the resistivity coming from the electrode portion (i.e., composite layer), which may account for active material particle size distribution, electrode porosity, dispersion, coating condition, etc. The interfacial resistance (on the right panel) represents the resistivity between the composite layer and current collector.

### EXAMPLES

An example of an Mn-based cathode according to some embodiments described herein includes the following components: 96 wt. % cathode active material, 2 wt. % binder, 1 wt. % carbon conducting agent, 0.8 wt. % MWCNT, and 0.2 wt. % functionalized MWCNT or rGO (reduced graphene oxide). However, this is only one example, and other ratios/amounts of the various components are feasible.

Generally, Mn-based cathodes prepared according to the embodiments described herein will include 94% or greater active material, less than or equal to 3 wt. % binder, less than or equal to 3 wt. % a mixture of carbon conducting agent and carbon nanotubes, and about 0.2 to about 2 wt. % functionalized carbon conducting agent.

In some embodiments, Mn-based cathodes according to embodiments described herein may comprise 94-99.9 wt. % active material. In some embodiments, Mn-based cathodes according to embodiments described herein may comprise less than or equal to 99.9, 99, 98, 97, 96, or 95 wt. % active material. In some embodiments, Mn-based cathodes according to embodiments described herein may comprise greater than or equal to 94, 95, 96, 97, 98, or 99 wt. % active material.

In some embodiments, Mn-based cathodes according to embodiments described herein may comprise 0.1-3 wt. % binder. In some embodiments, Mn-based cathodes according to embodiments described herein may comprise less than or equal to 3, 2, or 1 wt. % binder. In some embodiments, Mn-based cathodes according to embodiments described herein may comprise greater than or equal to 0.1, 1, 2, or 3 wt. % binder.

In some embodiments, Mn-based cathodes according to embodiments described herein may comprise 0.1-3 wt. % a mixture of carbon conducting agent and carbon nanotubes. In some embodiments, Mn-based cathodes according to embodiments described herein may comprise less than or equal to 3, 2, or 1 wt. % a mixture of carbon conducting agent and carbon nanotubes. In some embodiments, Mn-based cathodes according to embodiments described herein may comprise greater than or equal to 0.1, 1, 2, or 3 wt. % a mixture of carbon conducting agent and carbon nanotubes.

In some embodiments, Mn-based cathodes according to embodiments described herein may comprise about 0.2 to about 2 wt. % functionalized carbon conducting agent. In some embodiments, Mn-based cathodes according to embodiments described herein may comprise less than or equal to 2, 1.5, 1, or 0.5 wt. % functionalized carbon conducting agent. In some embodiments, Mn-based cathodes according to embodiments described herein may comprise greater than or equal to 0.2, 0.5, 1, or 1.5 wt. % functionalized carbon conducting agent.

### Battery Cells, Battery Modules, Battery Packs, and Electric Vehicle Systems

The manganese-based positive electrode materials comprising oxide-containing functional groups described above can be used in the fabrication of battery cells, rechargeable metal-ion batteries (e.g., lithium, sodium, potassium, aluminum, magnesium), and electric vehicle systems. More specifically, the manganese-based positive electrode materials comprising oxide-containing functional groups described herein may be used in the fabrication of battery cells that can be used to form battery modules, and/or battery packs. Battery cells, battery modules, and/or battery packs comprising a manganese-based positive electrode materials comprising oxide-containing functional groups described herein may then be used as a power source in electric vehicles. These embodiments are described in detail below.

Reference will now be made to implementations and embodiments of various aspects and variations of battery cells, battery modules, battery packs, and the methods of making such battery cells, battery modules, and battery packs. Although several exemplary variations of the battery cells, modules, packs, and methods of making them are described herein, other variations of the battery cells, modules, packs and methods may include aspects of the battery cells, modules, packs and methods described herein combined in any suitable manner having combinations of all or some of the aspects described. In addition, any part of or any of the electrodes, densified electrodes, components, systems, methods, apparatuses, devices, compositions, etc. described herein can be implemented into the battery cells, battery modules, battery packs, and methods of making these battery cells, battery modules, and battery packs.

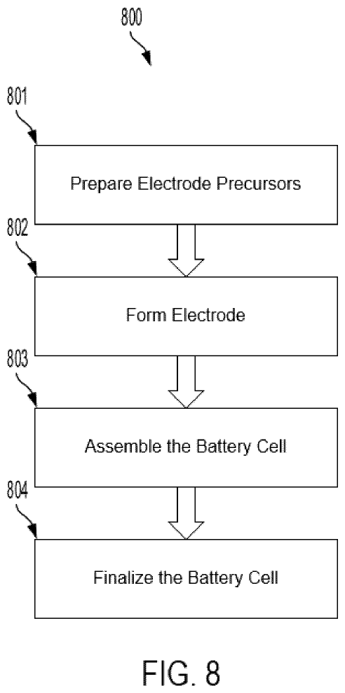

FIG. 8 illustrates a flow chart for a typical battery cell manufacturing process 800. These steps are not exhaustive and other battery cell manufacturing processes can include additional steps or only a subset of these steps. At step 801, the electrode precursors (e.g., binder, active material, conductive carbon additive) can be prepared. In some embodiments, this step can include mixing electrode materials (e.g., active materials) with additional components (e.g., binders, solvents, conductive additives, etc.) to form an electrode slurry. In some embodiment, this step can include synthesizing the electrode materials themselves.

At step 802, the electrode can be formed. In some embodiments, this step can include coating an electrode slurry on a current collector. In some embodiments, the electrode or electrode layer can include electrode active materials, conductive carbon material, binders, and/or other additives.

In some embodiments, the electrode active materials can include cathode active materials. In some embodiments, the cathode active materials can include olivine or phosphate-based cathode active materials. In some embodiments, the cathode active materials can include over-lithiated-oxide material (OLO), nickel-based cathode materials (e.g., nickel manganese cobalt (NMC) such as NMC111, NMC523, NMC622, NMC811, NMCA, nickel cobalt aluminum oxide (NCA), and Ni90+). In some embodiments, the cathode active materials can include high-nickel content (greater than or equal to about 80% Ni) lithium transition metal oxide. Such lithium transition metal oxides can include a particulate lithium nickel manganese cobalt oxide (“LiNMC”), lithium nickel cobalt aluminum oxide (“LINCA”), lithium nickel manganese cobalt aluminum oxide (“LiNMCA”), lithium cobalt oxide (LCO), lithium manganese oxide (LMO), lithium metal phosphates like lithium iron phosphate (“LFP”), lithium iron manganese phosphate (“LMFP”), sulfur containing cathode materials, lithium sulfide (LizS), lithium polysulfides, titanium disulfide (TiS₂), and combinations thereof.

In some embodiments, the electrode active materials can include anode active materials. In some embodiments, the anode active materials can include graphitic carbon (e.g., ordered or disordered carbon with sp2 hybridization, artificial or natural Graphite, or blended), Li metal anode, silicon-based anode (e.g., silicon-based carbon composite anode, silicon metal, oxide, carbide, pre-lithiated), silicon-based carbon composite anode, lithium alloys (e.g., Li—Mg, Li—Al, Li—Ag alloy), lithium titanate, or combinations thereof. In some embodiments, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell may not comprise an anode active material in an uncharged state.

In some embodiments, the conductive carbon material can include graphite, carbon black, carbon nanotubes, Super P carbon black material, Ketjen Black, Acetylene Black, SWCNT, MWCNT, carbon nanofiber, graphene, and combinations thereof.

In some embodiments, the binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”), carboxymethylcellulose (“CMC”), agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxy thiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (PIpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or combinations thereof.

After coating, the coated current collector can be dried to evaporate any solvent. In some embodiments, this step can include calendaring the coated current collectors. Calendaring can adjust the physical properties (e.g., bonding, conductivity, density, porosity, etc.) of the electrodes. In some embodiments, the electrode can then be sized via a slitting and/or notching machine to cut the electrode into the proper size and/or shape.

In some embodiments, solid electrolyte materials of the solid electrolyte layer can include inorganic solid electrolyte materials such as oxides, sulfides, phosphides, halides, ceramics, solid polymer electrolyte materials, hybrid solid state electrolytes, or glassy electrolyte materials, among others, or in any combinations thereof. In some embodiments, the solid electrolyte layer can include a polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B═Al, Ti), garnet-type with formula A₃B₂(XO₄)₃ (A=Ca, Sr, Ba and X═Nb. Ta), lithium phosphorous oxy-nitride (LixPOyNz), among others, or in any combinations thereof. In some embodiments, the solid electrolyte layer can include a glassy, ceramic and/or crystalline electrolyte material such as Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, lithium phosphorous oxy-nitride (LiₓPO_{y}N_{z}), lithium germanium phosphate sulfur (Li₁₀oGeP₂S₁₂), Yttria-stabilized Zirconia (YSZ), NASICON (Na₃Zr₂Si₂PO₁₂), beta-alumina solid electrolyte (BASE), perovskite ceramics (e.g., strontium titanate (SrTiO₃)), Lithium lanthanum zirconium oxide (La₃Li₇O₁₂Zr₂), LiSiCON (Li₂₊₂ₓZn₁₋ₓGeO₄), lithium lanthanum titanate (Li₃ₓLa_{2/3-x}TiO₃) and/or sulfide-based lithium argyrodites with formula Li₆PS₅X (X═Cl, Br) like Li₆PS₅Cl, among others, or in any combinations thereof. Furthermore, solid state polymer electrolyte materials can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), and PEG, among others, or in any combinations thereof.

At step 803, the battery cell can be assembled. After the electrodes, separators, and/or electrolytes have been prepared, a battery cell can be assembled/prepared. In this step, the separator and/or an electrolyte layer can be assembled between the anode and cathode layers to form the internal structure of a battery cell. These layers can be assembled by a winding method such as a round winding or prismatic/flat winding, a stacking method, or a z-folding method.

The assembled cell structure can then be inserted into a cell housing which is then partially or completed sealed. In addition, the assembled structure can be connected to terminals and/or cell tabs (via a welding process). For battery cells utilizing a liquid electrolyte, the housed cell with the electrode structure inside it can also be filled with electrolyte and subsequently sealed.

Battery cells can have a variety of form factors, shapes, or sizes. For example, battery cells (and their housings/casings) can have a cylindrical, rectangular, square, cubic, flat, or prismatic form factor, among others. There are four main types of battery cells: (1) button or coin cells: (2) cylindrical cells: (3) prismatic cells: and (4) pouch cells. Battery cells can be assembled, for example, by inserting a winding and/or stacked electrode roll (e.g., a jellyroll) into a battery cell casing or housing. In some embodiments, the winded or stacked electrode roll can include the electrolyte material. In some embodiments, the electrolyte material can be inserted in the battery casing or housing separate from the electrode roll. In some embodiments, the electrolyte material includes, but is not limited to, an ionically conductive fluid or other material (e.g., a layer) that can allow the flow of electrical charge (i.e., ion transportation) between the cathode and anode. In some embodiments, the electrolyte material can include a non-aqueous polar solvent (e.g., a carbonate such as ethylene carbonate, propylene carbonate, diethyl carbonate, ethyl methyl carbonate, dimethyl carbonate, or a mixture of any two or more thereof). The electrolytes may also include other additives such as, but not limited to, vinylidene carbonate, fluoroethylene carbonate, ethyl propionate, methyl propionate, methyl acetate, ethyl acetate, or a mixture of any two or more thereof. The lithium salt of the electrolyte may be any of those used in lithium battery construction including, but not limited to, lithium perchlorate, lithium hexafluorophosphate, lithium bis(fluorosulfonyl)imide, lithium bis(trifluorosulfonyl)imide, or a mixture of any two or more thereof. In addition, the salt may be present in the electrolyte from greater than 0 M to about 5 M, or for example salt may be present between about 0.05 to 2 M or about 0.1 to 2 M.

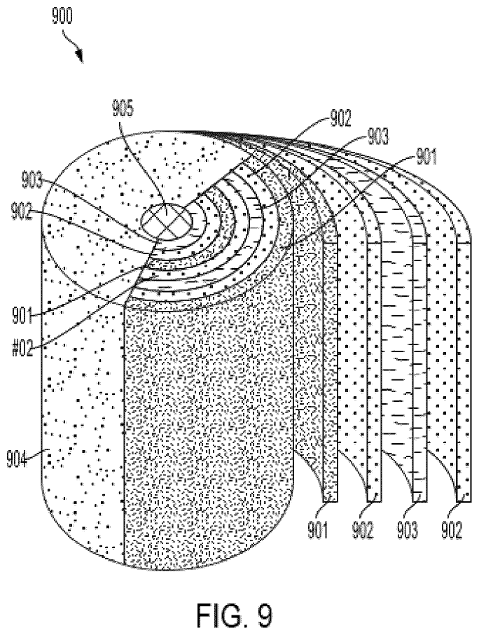

FIG. 9 depicts an illustrative example of a cross sectional view of a cylindrical battery cell 900. The cylindrical battery cell can include layers (e.g., sheet-like layers) of anode layers 901, separator and/or electrolyte layers 902, and cathode layers 903.

A battery cell can include at least one anode layer, which can be disposed within the cavity of the housing/casing. The battery cell can also include at least one cathode layer. The at least one cathode layer can also be disposed within the housing/casing. In some embodiments, when the battery cell is discharging (i.e., providing electric current), the at least one anode layer releases ions (e.g., lithium ions) to the at least one cathode layer generating a flow of electrons from one side to the other. Conversely, in some embodiments, when the battery cell is charging, the at least one cathode layer can release ions and the at least one anode layer can receive these ions.

These layers (cathode, anode, separator/electrolyte layers) can be sandwiched, rolled up, and/or packed into a cavity of a cylinder-shaped casing 904 (e.g., a metal can). The casings/housings can be rigid such as those made from metallic or hard-plastic, for example. In some embodiments, a separator layer (and/or electrolyte layer) 902 can be arranged between an anode layer 901 and a cathode layer 903 to separate the anode layer 902 and the cathode layer 903. In some embodiments, the layers in the battery cell can alternate such that a separator layer (and/or electrolyte layer) separates an anode layer from a cathode layer. In other words, the layers of the battery electrode can be (in order) separator layer, anode/cathode layer, separator layer, opposite of other anode/cathode layer and so on. The separator layer (and/or electrolyte layer) 902 can prevent contact between the anode and cathode layers while facilitating ion (e.g., lithium ions) transport in the cell. The battery cell can also include at least one terminal 905. The at least one terminal can be electrical contacts used to connect a load or charger to a battery cell. For example, the terminal can be made of an electrically conductive material to carry electrical current from the battery cell to an electrical load, such as a component or system of an electric vehicle as discussed further herein.

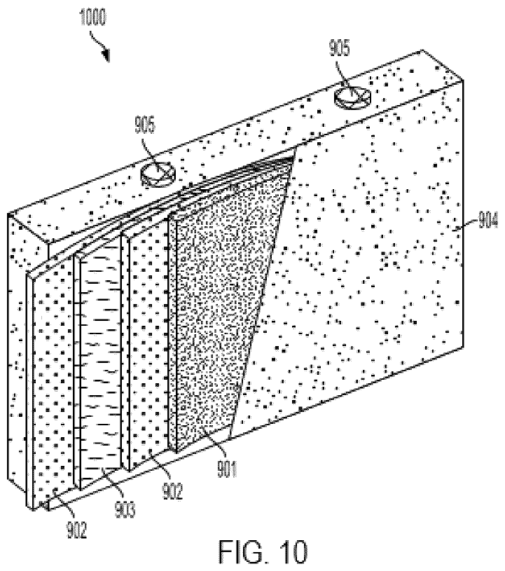

FIG. 10 depicts an illustrative example of a cross sectional view of a prismatic battery cell 1000. The prismatic battery cell can include layers (e.g., sheet-like layers) of anode layers 901, separator and/or electrolyte layers 902, and cathode layers 903. Similar to the cylindrical battery cell, the layers of a prismatic battery cell can be sandwiched, rolled, and/or pressed to fit into cubic or rectangular cuboid (e.g., hyperrectangle) shaped casing/housing 904. In some embodiments, the layers can be assembled by layer stacking rather than jelly rolling. In some embodiments, the casing or housing can be rigid such as those made from a metal and/or hard-plastic. In some embodiments, the prismatic battery cell 1000 can include more than one terminal 905. In some embodiments, one of these terminals can be the positive terminal and the other a negative terminal. These terminals can be used to connect a load or charger to the battery cell.

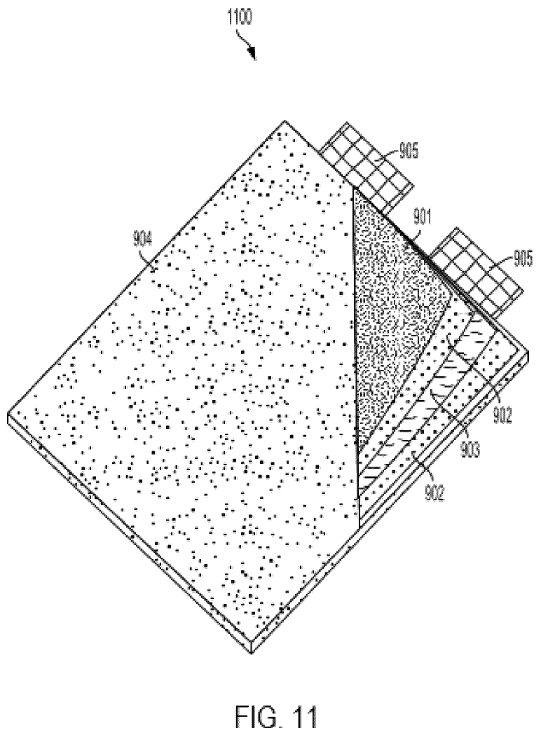

FIG. 11 depicts an illustrative example of a cross section view of a pouch battery cell 1100. The pouch battery cells do not have a rigid enclosure and instead use a flexible material for the casing/housing 904. This flexible material can be, for example, a sealed flexible foil. The pouch battery cell can include layers (e.g., sheet-like layers) of anode layers 901, separator and/or electrolyte layers 902, and cathode layers 903. In some embodiments, these layers are stacked in the casing/housing. In some embodiments, the pouch battery cell 1100 can include more than one terminal 905. In some embodiments, one of these terminals can be the positive terminal and the other the negative terminal. These terminals can be used to connect a load or charger to the battery cell.

The casings/housings of battery cells can include one or more materials with various electrical conductivity or thermal conductivity, or a combination thereof. In some embodiments, the electrically conductive and thermally conductive material for the casing/housing of the battery cell can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. In some embodiments, the electrically conductive and thermally conductive material for the housing of the battery cell can include a ceramic material (e.g., silicon nitride, silicon carbide, titanium carbide, zirconium dioxide, beryllium oxide, and among others) and/or a thermoplastic material (e.g., polyethylene, polypropylene, polystyrene, polyvinyl chloride, or nylon), among others.

At step 804, the battery cell can be finalized. In some embodiments, this step includes the formation process wherein the first charging and discharging process for the battery cell takes place. In some embodiments, this initial charge and discharge can form a solid electrolyte interface between the electrolyte and the electrodes. In some embodiments, this step may cause some of the cells to produce gas which can be removed in a degassing process from the battery cell. In some embodiments, this step includes aging the battery cell. Aging can include monitoring cell characteristics and performance over a fixed period of time. In some embodiments, this step can also include testing the cells in an end-of-line (EOL) test rig. The EOL testing can include discharging the battery cells to the shipping state of charge, pulse testing, testing internal resistance measurements, testing OCV, testing for leakage, and/or optically inspecting the battery cells for deficiencies.

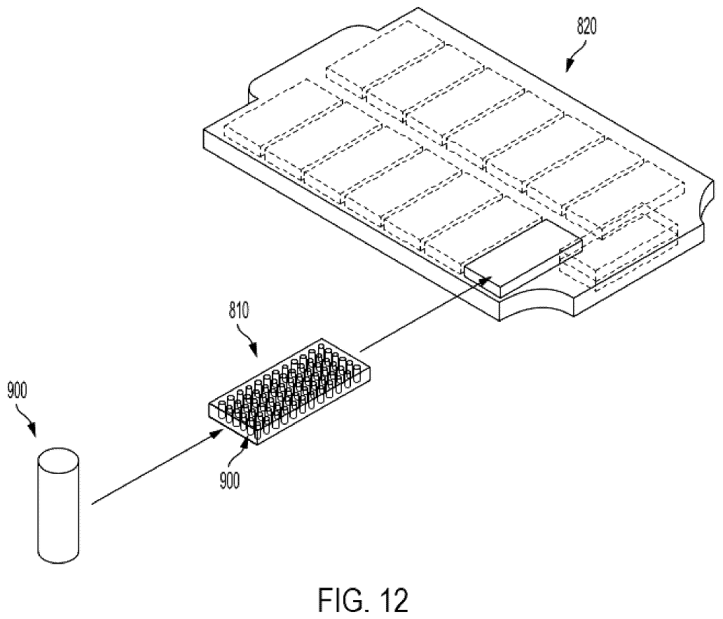

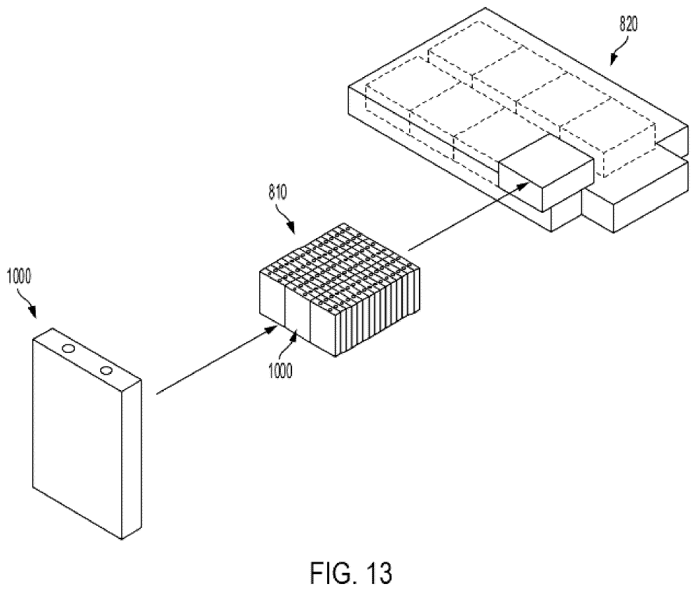

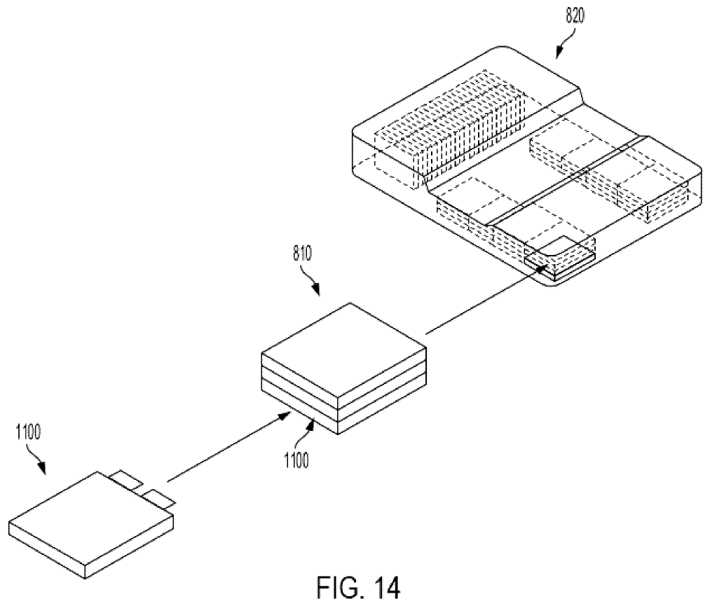

A plurality of battery cells (900, 1000, and/or 1100) can be assembled or packaged together in the same housing, frame, or casing to form a battery module and/or battery pack. The battery cells of a battery module can be electrically connected to generate an amount of electrical energy. These multiple battery cells can be linked to the outside of the housing, frame, or casing, through a uniform boundary. The battery cells of the battery module can be in parallel, in series, or in a series-parallel combination of battery cells. The housing, frame, or casing can protect the battery cells from a variety of dangers (e.g., external elements, heat, vibration, etc.). FIG. 12 illustrates cylindrical battery cells 900 being inserted into a frame to form battery module 810. FIG. 13 illustrates prismatic battery cells 1000 being inserted into a frame to form battery module 810. FIG. 14 illustrates pouch battery cells 1100 being inserted into a frame to form battery module 810. In some embodiments, the battery pack may not include modules. For example, the battery pack can have a “module-free” or cell-to-pack configuration wherein battery cells are arranged directly into a battery pack without assembly into a module.

A plurality of the battery modules 810 can be disposed within another housing, frame, or casing to form a battery pack 820 as shown in FIGS. 12-14. In some embodiments, a plurality of battery cells can be assembled, packed, or disposed within a housing, frame, or casing to form a battery pack (not shown). In such embodiments, the battery pack may not include a battery module (e.g., module-free). For example, the battery pack can have a module-free or cell-to-pack configuration where the battery cells can be arranged directly into a battery pack without assembly into a battery module. In some embodiments, the battery cells of the battery pack can be electrically connected to generate an amount of electrical energy to be provided to another system (e.g., an electric vehicle).

The battery modules of a battery pack can be electrically connected to generate an amount of electrical energy to be provided to another system (e.g., an electric vehicle). The battery pack can also include various control and/or protection systems such as a heat exchanger system (e.g., a cooling system) configured to regulate the temperature of the battery pack (and the individual modules and battery cells) and a battery management system configured to control the battery pack's voltage, for example. In some embodiments, a battery pack housing, frame, or casing can include a shield on the bottom or underneath the battery modules to protect the battery modules from external elements. In some embodiments, a battery pack can include at least one heat exchanger (e.g., a cooling line configured to distribute fluid through the battery pack or a cold plate as part of a thermal/temperature control or heat exchange).

In some embodiments, battery modules can collect current or electrical power from the individual battery cells that make up the battery modules and can provide the current or electrical power as output from the battery pack. The battery modules can include any number of battery cells and the battery pack can include any number of battery modules. For example, the battery pack can have one, two, three, four, five, six, seven, eight, nine, ten, eleven, twelve or other number of battery modules disposed in the housing/frame/casing. In some embodiments, a battery module can include multiple submodules. In some embodiments, these submodules may be separated by a heat exchanger configured to regulate or control the temperature of the individual battery module. For example, a battery module can include a top battery submodule and a bottom battery submodule. These submodules can be separated by a heat exchanger such as a cold plate in between the top and bottom battery submodules.

The battery packs can come in all shapes and sizes. For example, FIGS. 12-14 illustrates three differently shaped battery packs 820. As shown in FIGS. 12-14, the battery packs 820) can include or define a plurality of areas, slots, holders, containers, etc. for positioning of the battery modules. The battery modules can come in all shapes and sizes. For example, the battery modules can be square, rectangular, circular, triangular, symmetrical, or asymmetrical. In some examples, battery modules in a single battery pack may be shaped differently. Similarly, the battery module can include or define a plurality of areas, slots, holders, containers, etc. for the plurality of battery cells.

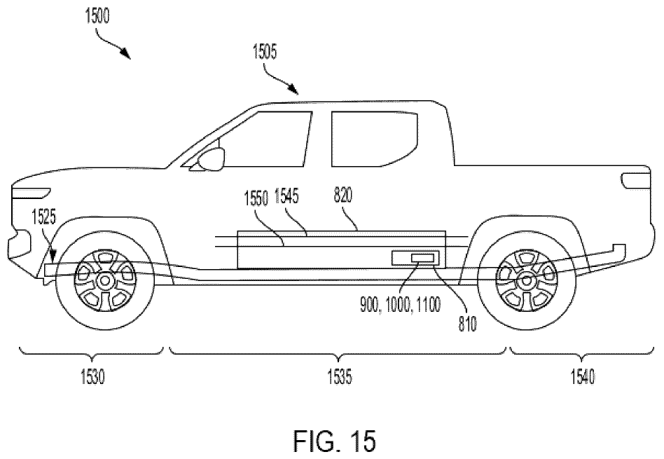

FIG. 15 illustrates an example of a cross sectional view 1500 of an electric vehicle 1505 that includes at least one battery pack 820. Electric vehicles can include, but are not limited to, electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. Electric vehicles can be fully electric or partially electric (e.g., plug-in hybrid) and further, electric vehicles can be fully autonomous, partially autonomous, or unmanned. In addition, electric vehicles can also be human operated or non-autonomous.

Electric vehicles 1505 can be installed with a battery pack 820 that includes battery modules 810 with battery cells (900, 1000, and/or 1100) to power the electric vehicles. The electric vehicle 1505 can include a chassis 1525 (e.g., a frame, internal frame, or support structure). The chassis 1525 can support various components of the electric vehicle 1505. In some embodiments, the chassis 1525 can span a front portion 1530 (e.g., a hood or bonnet portion), a body portion 1535, and a rear portion 1540 (e.g., a trunk, payload, or boot portion) of the electric vehicle 1505. The battery pack 820 can be installed or placed within the electric vehicle 1505. For example, the battery pack 820 can be installed on the chassis 1525 of the electric vehicle 1505 within one or more of the front portion 1530, the body portion 1535, or the rear portion 1540. In some embodiments, the battery pack 820 can include or connect with at least one busbar, e.g., a current collector element. For example, the first busbar 1545 and the second busbar 1550 can include electrically conductive material to connect or otherwise electrically couple the battery pack 820 (and/or battery modules 810 or the battery cells 900, 1000, and/or 1100) with other electrical components of the electric vehicle 1505 to provide electrical power to various systems or components of the electric vehicle 1505. In some embodiments, battery pack 820 can also be used as an energy storage system to power a building, such as a residential home or commercial building instead of or in addition to an electric vehicle.

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

Reference to “about” a value or parameter herein includes (and describes) variations that are directed to that value or parameter per se. For example, description referring to “about X” includes description of “X”. In addition, reference to phrases “less than”, “greater than”, “at most”, “at least”, “less than or equal to”, “greater than or equal to”, or other similar phrases followed by a string of values or parameters is meant to apply the phrase to each value or parameter in the string of values or parameters.

This application discloses several numerical ranges in the text and figures. The numerical ranges disclosed inherently support any range or value within the disclosed numerical ranges, including the endpoints, even though a precise range limitation is not stated verbatim in the specification because this disclosure can be practiced throughout the disclosed numerical ranges.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A lithium-ion battery comprising:
a positive electrode comprising a first conducting agent comprising one or more oxide containing functional groups.

2. The lithium-ion battery of claim 1, wherein the first conducting agent comprises: graphene, graphite, graphene oxide, graphite oxide, reduced graphene oxide, single-walled nanotubes, multiwalled-nanotubes, or a combination thereof.

3. The lithium-on battery of claim 1, wherein the positive electrode comprises a second conducting agent.

4. The lithium-ion battery of claim 3, wherein a weight ratio of the second conducting agent to the first conducting agent is 2: 1 to 9:1.

5. The lithium-ion battery of claim 3, wherein the first conducting agent comprises multiwalled carbon nanotubes, the second conducting agent comprises multiwalled carbon nanotubes, or a combination thereof.

6. The lithium-ion battery of claim 3, wherein the first conducting agent comprises single walled carbon nanotubes, the second conducting agent comprises single walled carbon nanotubes, or a combination thereof.

7. The lithium-ion battery of claim 1, wherein the first conducting agent comprises functionalized carbon nanotubes.

8. The lithium-ion battery of claim 7, wherein a flake size of graphene oxide used to form the functionalized carbon nanotubes of the first conducting agent is from 0.1 to 25 μm.

9. The lithium-ion battery of claim 7, wherein a flake size of graphene oxide used to form the functionalized carbon nanotubes of the first conducting agent is from 0.1-2 μm.

10. The lithium-ion battery of claim 7, wherein a ratio of flake size of graphene oxide used to form the functionalized carbon nanotubes of the first conducting agent to a particle size of an active material is 2:1-40:1.

11. The lithium-ion battery of claim 1, wherein the one or more oxide-containing functional groups is configured to react with manganese ions.

12. The lithium-ion battery of claim 1, wherein the one or more oxide-containing functional groups is configured to react with residual water.

13. The lithium-ion battery of claim 1, wherein the one or more oxide-containing functional groups is configured to react with hydrogen fluoride.

14. The lithium-ion battery of claim 1, wherein the one or more oxide-containing functional groups is configured to react with nitrogen ions, phosphorus ions, sulfur ions, or a combination thereof.

15. The lithium-ion battery of claim 1, wherein the positive electrode comprises LMFP, LMO, LiMO₂, Li₁₊ₓM₁₋ₓO₂, Li₂MnO₃, or a combination thereof.

16. The lithium-ion battery of claim 1, wherein the one or more oxide-containing functional groups comprise a carbonyl functional group, a carboxylic functional group, an epoxy functional group, a hydroxyl functional group, or a combination thereof.

17. The lithium-ion battery of claim 1, wherein the positive electrode comprises 90-99 wt. % active material, 0.5-5 wt. % conducting agent, and 0.5-5 wt. % binder.

18. An electric vehicle system comprising the lithium-ion battery of claim 1.

19. A method of preparing a cathode, the method comprising:
mixing a first conducting agent, a binder, a solvent, an active material, and a second conducting agent to form an electrode slurry, wherein the first conducting agent comprises one or more oxide-containing functional groups.

20. The method of claim 19, wherein the first conducting agent is added to the mixture after the mixing the second conducting agent, the binder, then solvent, and the active material.
